(19) United States
(12) Patent Application Publication
(10) Pub. No.: US 2026/0241591 A1
(43) Pub. Date: Aug. 20, 2026

(54) Shaver

(71) Applicant: Shraga Weiss, Denver, CO (US)

(72) Inventor: Shraga Weiss, Denver, CO (US)

(21) Appl. No.: 19/542,390

(22) Filed: Feb. 17, 2026

Related U.S. Application Data
(60) Provisional application No. 63/761,014, filed on Feb. 20, 2025.

(51) Int. Cl. B26B 21/52; B26B 21/40

(52) U.S. Cl. CPC B26B 21/522; B26B 21/4012; B26B 21/4081; B26B 21/527

(57) ABSTRACT

A shaver or trimmer and method of hair removal are disclosed that enable the user to remove hair without seeing the hair patch. The shaver or trimmer may be held in one hand while allowing the fingers to feel around the shaver or trimmer to determine the location of cutting and manipulate the device in the correct path.

### CROSS REFERENCE TO RELATED APPLICATIONS

This application claims the benefit of the provisional application US Serial Number 63/761,014 filed on February 20, 2025. This application is related to US Design Application Number 29/991,504 filed on February 28, 2025, which is pending.

### BACKGROUND

Many devices and methods are designed to facilitate personal grooming, in particular hair removal or trimming. Shaving or trimming is one of the most ubiquitous and repetitive grooming procedures in modern life. Both men and women routinely shave or trim, sometimes daily. And shaving and trimming are performed on many parts of the body. Some of those parts are difficult to reach or difficult to see.

Despite the thousands of various shaver or trimmer products on the market, no good options exist that allows feeling the location to be shaved or trimmed where there is no good visibility. Accordingly, a need exists for a shaver or trimmer which allows hair removal in areas that are not easily visible to the user.

### SUMMARY OF INVENTION

The present disclosure provides a device and method for hair removal or trimming in areas which are not easy to see by the user. To be sure, the present disclosure may also be used for hair removal where visibility is good. The configuration of the present shaver or trimmer improves the user’s ability to shave or trim by feel, thereby making it more accurate and repeatable. But it also allows for accurate shaving or trimming where visibility is lacking or is poor. In the following paragraphs, the words shaver or shave are used to refer to shaving, trimming, and removal of all or part of hair using a sharp edge or blade, categorically referred to as blade.

### BRIEF DESCRIPTION OF DRAWINGS

FIG. 1 is an illustration of a user holding one embodiment of the shaver against the back of his neck.

FIG. 2 is a perspective view of one embodiment of the shaver from the top and showing the leading edge.

FIG. 3 is a perspective view of one embodiment of the shaver from the bottom and showing the leading edge.

FIG. 4 is a perspective view of one embodiment of the shaver from the bottom and showing a blade insert assembly removed.

FIG. 5 is a perspective view of an embodiment of the shaver from the bottom and showing an embodiment of a blade insert assembly removed.

FIG. 6 is a cross section along line 6-6 as shown in FIG. 2.

FIG. 7 is a cross section along line 7-7 as shown in FIG. 2.

FIG. 8 is another illustration of a user holding one embodiment of the shaver against the back of his neck where the user’s finger extends beyond the edge of the shaver.

FIG. 9 is another illustration of a user holding one embodiment of the shaver.

FIG. 10 is an illustration of a user holding an alternative configuration of a shaver.

FIG. 11 shows the alternative configuration of FIG. 13 without the user’s hand.

FIG. 12 is an illustration of a user holding yet another alternative embodiment of a shaver.

FIG. 13 is a top perspective view of the embodiment of the shaver in FIG. 12 without the user’s hand.

FIG. 14 is a view of the embodiment of the shaver in FIG. 12 from a bottom perspective.

FIG. 15 is an illustration of a user holding yet another alternative embodiment of a shaver.

FIG. 16 is a top perspective view of the embodiment of the shaver in FIG. 15 without the user’s hand.

FIG. 17 is a bottom perspective view of the embodiment of the shaver in FIG. 15 showing circular trimming heads which contain cutting blades for hear removal.

FIG. 18 is an illustration of a user holding yet another alternative embodiment of a shaver wand with the user’s finger against the head of the wand which contains one or more cutting blades.

FIG. 19 is a perspective view of the shaver wand as shown in FIG. 18.

FIG. 20 is a closeup top perspective view of the wand showing the back of the head opposite the side where the blade or blades are located.

FIG. 21 is an illustration of a user holding yet another alternative embodiment of a shaver between two fingers.

FIG. 22 is a perspective view of the shaver shown in FIG. 21.

FIG. 23 is a bottom perspective of the shaver shown in FIG. 21 showing the cutting edges.

FIG. 24 is an exploded view of yet another embodiment of a shaver with its razor blades.

### DETAILED DESCRIPTION

In the following detailed description, specific details are set forth by way of examples in order to provide a thorough understanding of the relevant teachings of this disclosure. It should be noted, however, that the present teachings may be practiced without such details.

The foregoing shaver and method are set forth concisely to better disclose the inventions herein. Structures, methods, procedures, and components have been described at a relatively high level. In those instances, the disclosure provides sufficient detail to describe and enable it to a person of ordinary skill but avoids providing so much detail as to obscure aspects of the invention.

Therefore, at times, the disclosures may omit extra details when not necessary to convey this understanding. The disclosures may also disclose multiple alternatives and embodiments aimed at improving this understanding. Accordingly, the disclosed invention is not limited by the foregoing explanations but rather illuminated by the full scope of what it teaches to a person having ordinary skill in the art.

The present disclosure provides an efficient, fast, easy, and cost-effective shaver, and method of hair removal, that has an aesthetically pleasing design. The present disclosure additionally provides a solution to accurately shaving in the back of the neck and other areas which without “seeing” the hair. The present shaver features an ergonomic shape that fits naturally in the user’s hand, allowing tactile guidance to more accurately direct the cutting edge along the hairline. Unlike traditional razors, which require awkward positioning and reliance on visual aids, this device integrates user-friendly design principles to simplify and improve self-shaving.

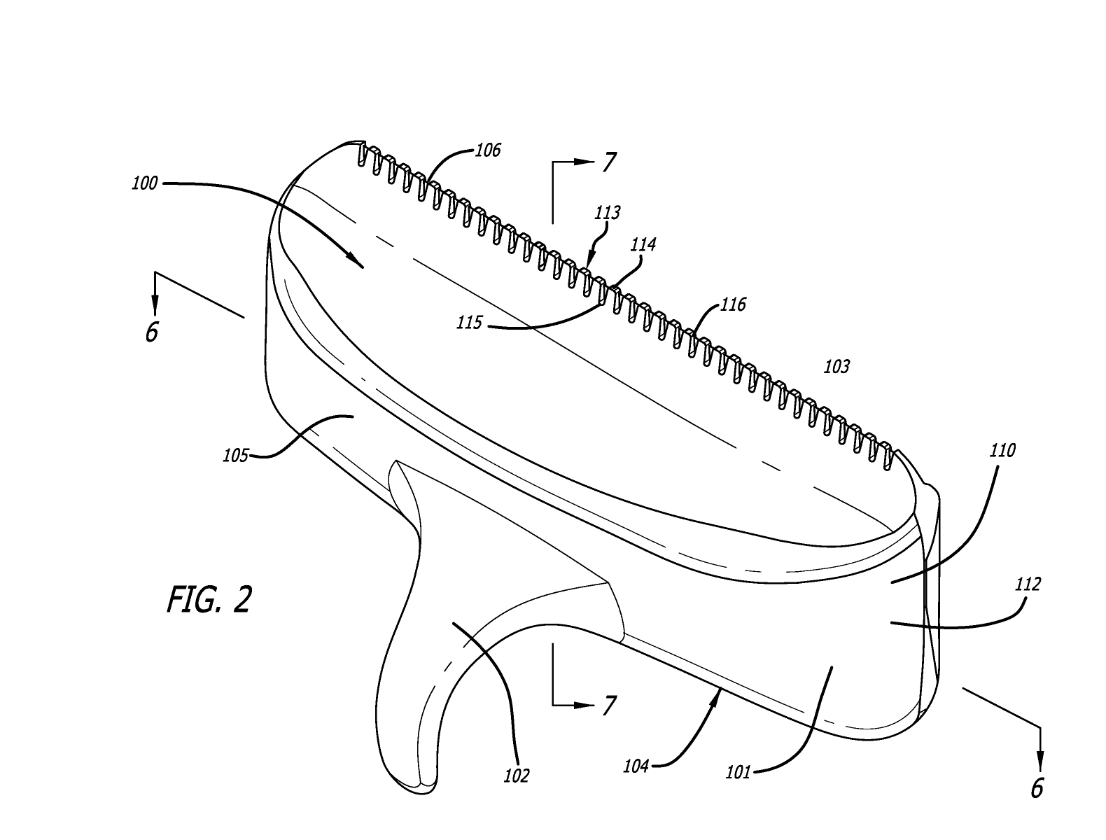

Referring to FIG. 2, shaver 100 is comprised of a body 101 and a handle 102. The shaver body has a top 105, bottom 106, front 103, back 104, and sides 112. The body may be generally rectangular with generally flat surfaces, or it may include curved surfaces. The curvatures of the surfaces enhance the aesthetic appeal of the shaver. The curvatures may additionally facilitate use depending on how the device is held. In some embodiments, the sides may blend together continuously such that a single continuous surface defines the top and sides or the top and back or front, etc.

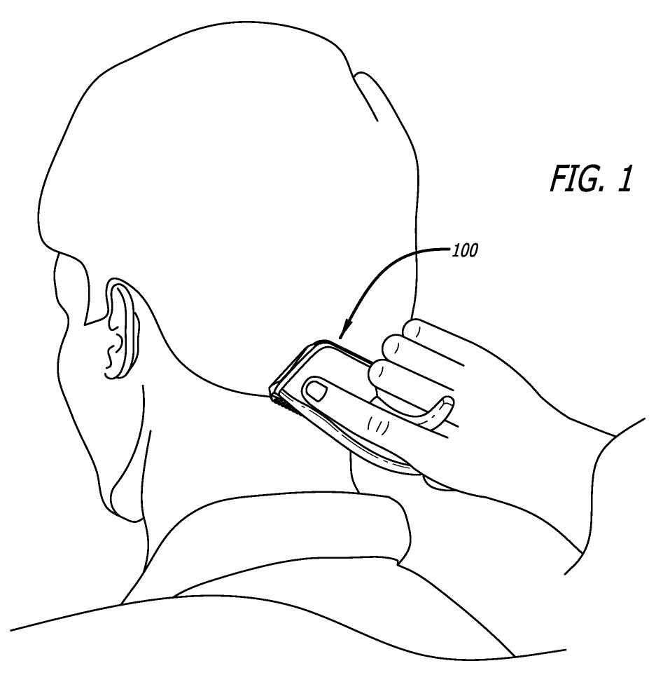

Handle 102 may be functional or ornamental depending on how the device is held or used. In one embodiment , as shown in FIG. 1, the handle 102 may be used to secure the shaver between the fingers. In such a case, the specific shape of the handle may be ornamental.

FIG. 7 shows a cross section of the shaver 100 along section 7-7. In FIG. 7, the profile contour of the embodiment of FIG. 2 is visible. The top edge of 103 forms a lip 108. The lip 108 provides a protrusion which abuts the finger as shown in FIG. 1. The base 109 of the handle 102, may be designed to abut the finger on the opposite side as of lip 108. In this way, the finger, as shown in FIG. 1, may be cradled between the two edges 108 and 109.

For additional comfort, as well as increased aesthetic appeal, the outer surface 105 may include a concave curve 111 (FIG. 7) in which the finger may rest. In practice, this concavity may be slight and be limited to the area between the handle 102 and lip 108, blending into a convex surface at 110 (FIG. 2). Alternatively, it may extend along the entire top surface. Alternatively, it can extend around any portion or all of the perimeter of the shaver 100.

The sides 112 may include dips or depressions which are not contiguous with the curve 111. One or both sides 112 may include dips. Dips can be strategically placed on various locations on the surface 105 to improve grip. Alternatively, the surface may be textured in all or some portions to facilitate grip. Alternatively, the exterior surfaces may be made flat instead of curved.

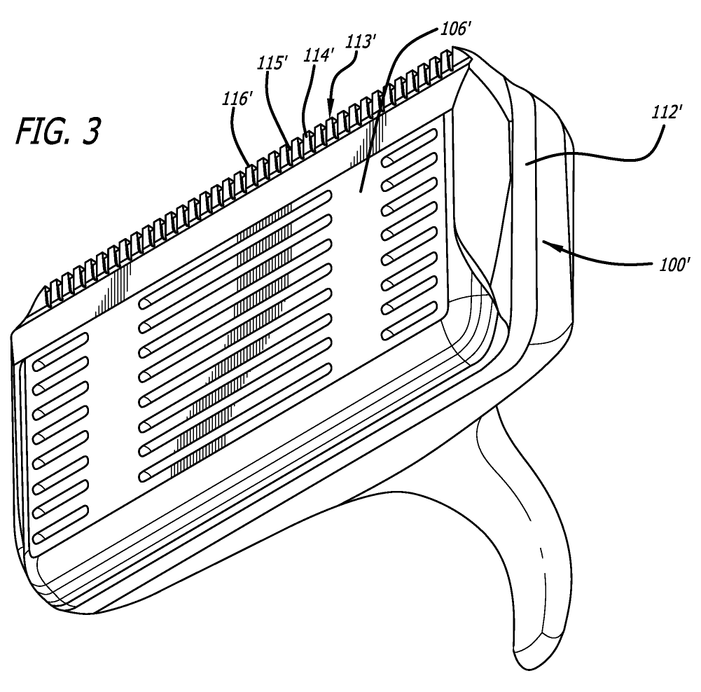

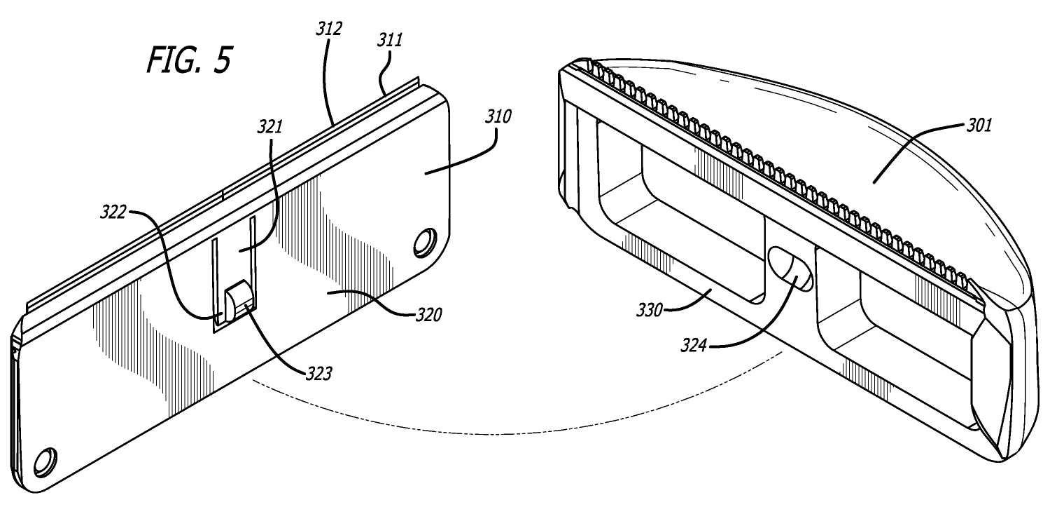

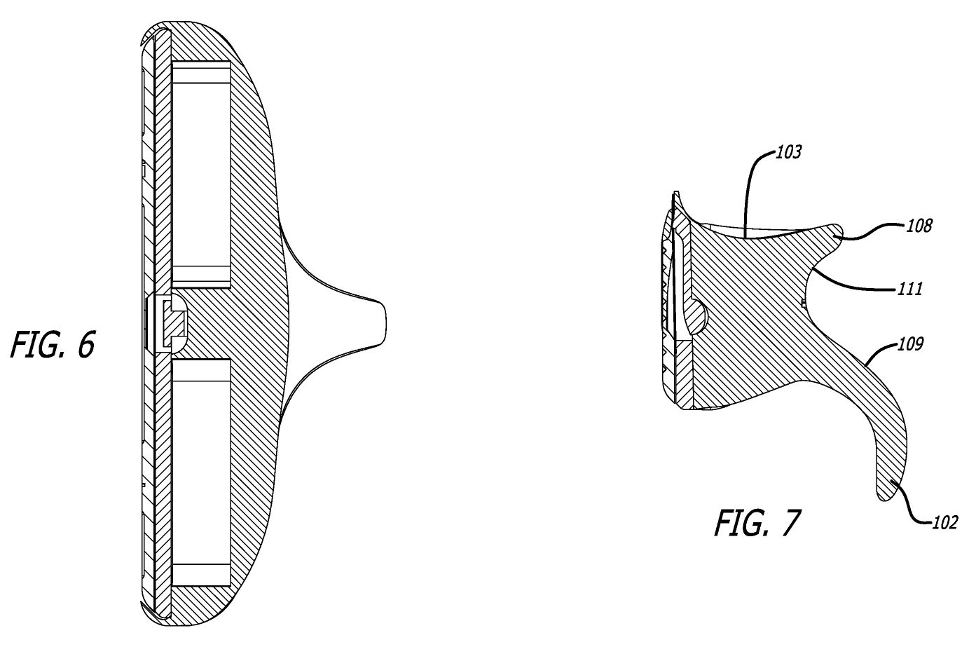

Moreover, sides 112 may be flat or have a different curvature than that shown in FIG. 2. A longitudinal cross section of the shaver body according to the embodiment of FIG. 2 can be seen in FIG. 6, which is a cross section along line 6-6 as shown in FIG. 2. FIG. 3 shows alternative embodiment 100’ with sides 112’ which have a different concavity than that shown in FIG. 2.

The handle 102 may be omitted from the shaver 100 but its inclusion allows the shaver to be held in certain configurations, such as FIG. 1, more securely. In FIG. 2, the handle is shown to curve towards the rear surface 104. Alternatively, it may bend forward towards surface 103. The handle may be made unitary with the body 101 as shown in FIG. 7. Or it may attach to the body by fasteners or by adhesive or by welding or by fusing.

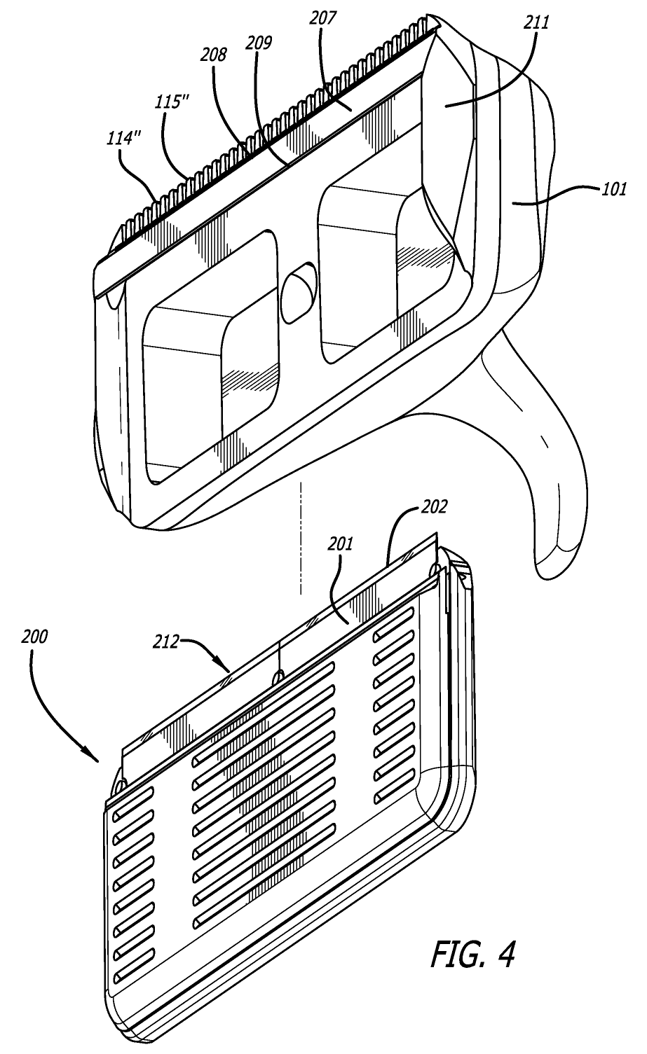

FIG. 2 shows the top view of the leading edge 113. In the present embodiment, the edge 113 also defines the cutting edge. Returning to FIG. 3, the under side 106’ is generally similar to under side 106 of shaver 100 (FIG. 2). The leading edge 113 includes teeth 114 with recesses or spaces 115. Correspondingly, in FIG. 3, leading 113’ includes teeth 114’ and recesses or spaces 115’. The sharp edge of one or more blades is exposed in recesses 115, as shown in FIG. 2 (115’ in FIG. 3), and will shear hair on contact. (See FIG. 4 for sharp edge 202 of blade 201.) The tips of the teeth may be rounded at their edges such as that depicted at 116 in FIG. 2 or may not be rounded as shown at 116’ in FIG. 3.

The shaver may include a blade in a permanent or removable configuration. The blade may be directly placed into the shaver, or the blade may be in a blade assembly or cartridge that is placed into the shaver. FIG. 4 shows a blade insert assembly or cartridge 200 which has a bottom surface 206 that forms the bottom surface of the shaver for example as depicted as 106’ in FIG. 3. The cartridge may slide or snap into place. Alternatively, it may be secured in place with a fastener—such as one or more screws. One edge of the cartridge includes blade 201 with a sharp edge 202 which is the cutting edge.

The cartridge 200, as shown in FIG. 4, may slide into the body 101 of the shaver at which time the blade 201 slides under blade cover 207. Blade cover 207 has a first edge 208 and a second edge 209. As the blade 201 slides from the second edge 209 towards the first edge 208, it becomes seated in place such that some of the blade edge 202 is revealed in the spaces 115” between teeth 114” and will come into contact with hair.

The particular coupling of a cartridge with the body of a shaver may take different forms. As shown in FIG. 4, the cartridge may slide into place under edge 207. A tab 212 (FIG. 4), for example a leaf spring, may create additional grip in maintaining the cartridge in place. Alternatively, the sides 201 may be folded at edges 211 to create channels into which the cartridge 200 can slide and be securely gripped. Alternatively, the cartridge may be screwed or otherwise fastened in place.

When the cartridge 200 is slid, snapped, or otherwise secured in place in the shaver, the cutting edge 202 of the blade is exposed in spaces 115, as shown in FIG. 2 (115’ as shown in FIG. 3). The movement of the leading edge 106 against hair forces the hair into spaces 115 and in contact with the blade edge 202. This contact results in the hair being sheered upon contact. The teeth act as a safety mechanism to keep skin away from the blade’s cutting edge.

In some embodiments the top of a cartridge may include a tab or snap to snap it in place by making contact with a lower surface of a shaver body. FIG. 5 shows a shaver body 301 with cartridge 310 including a blade 311 with a cutting edge 312. The cartridge 310 includes top surface 320 with a tab 321. The tab includes a leaf spring 322 and a protrusion 323. When the cartridge is placed in the shaver body 301, the top surface 320 contacts bottom surface 330 of the shaver body. This contact bends the tab 321 back until the protrusion 323 is aligned with opening 324. As the cartridge moves into place, the opening 324 aligns with protrusion 323 and protrusion 323 goes into the opening 324 allowing the leaf spring 322 to snap forward and snap the tab 321 into place and further secure the cartridge to the body 301.

Other modifications are also contemplated herein. In other alternative embodiments, multiple tabs 321 may be placed on surface 320; for example, one on each end. The width of the blade 311 may be made less than the leading edge 312. The tabs may be replaced by other snap mechanisms or fasteners. In yet other embodiments, a blade or blades may be directly received into the shaver without the use of a cartridge. FIG. 24 shows such an alternative embodiment where two razor blades are slid under a tab in the shaver and against the cutting surface, then secured in place with screws.

In yet another embodiment, a shaver handle may be a loop, defining a hole for receiving a finger of the user. In another embodiment, the handle may include more than one hold for receiving multiple fingers. In other embodiments, the handle may be eliminated altogether.

In one embodiment, the present shaver may be used by holding the body between the index finger and thumb, with the index finger laying on the top (105 in FIG. 2) and the thumb resting on the face 103 (FIGS. 1 and 8-9). The remaining fingers may support the shaver on back side 104 or may curl onto the bottom 106. For those with sufficiently long fingers, the tip of the index finger may wrap around side 110 and extend beyond to feel the skin and hair on the shaving surface. This configuration is shown in FIG. 8. A similar holding configuration is shown in FIG. 9 but showing the blade-side of the device. In this configuration, the body may be generally gripped parallel to the cutting edge of the blade. When held in this manner, the thumb and index finger may feel the hair or skin and will accurately guide the shaver along the path to be shaved. The shaving motion can be along the hairline, or towards the hairline, or away from the hairline (for example in trimming the back of the neck from the hair down towards the shoulders.

When using this grip, the leading edge of the shaver with the blade is placed near the edge of the hair. The thumb, resting on the face of 103, may be positioned to feel alongside the edge of the hair at the bottom of the neckline (back of neck hairline) allowing the user to shave the neck while maintaining the hair along the neckline. The tip of the index finger extends over 110 and is positioned to feel alongside the hair line the extends down from below the ear to the neckline allowing one to shave the hair on the side of the hairline from the ear down to the neckline while maintaining the hair along the hairline. The middle, ring, and pinky fingers may be used to add additional context by feeling around the back side of the shaver alongside the cartridge. In this way, the hand both holds the shaver and also feels the skin and hairline, so that it may guide the shaver along the desired boundary to cut the hair.

In an alternative embodiment, all of the fingers may be curled under with the handle 102 located between the folded index and middle fingers and curving over the middle finger. The thumb folds onto surface 103 and pushes against it to firmly grip the shaver in hand. The ring finger and pinky may curl under or be free to feel the hair line. Here too, the shaver body is gripped in a direction generally parallel to the cutting edge of the blade.

In yet another alternative embodiment, the handle may be grasped between the thumb and index finger, wrapping around the thumb, and the remaining fingers curled onto and pressing against surface 103. In this configuration, and if the handle is curved as shown in FIG. 2, the tip of the handle curves partially around the thumb and the index finger may also be placed on surface 103. Here too, the grip is generally parallel to the cutting edge.

In yet another alternative embodiment, the handle may be grasped between the thumb and index finger, wrapping around the thumb, and the remaining fingers curled onto and pressing against surface 103. In this configuration, and if the handle is curved as shown in FIG. 2, the tip of the handle curves partially around the thumb and the index finger may also be placed on surface 103.

In yet another alterative embodiment, the thumb may be pressed on surface 103 on the leading edge of the shaver with the remaining fingers pressed against the back surface 104. The index, middle, ring, and pinky fingers may be curved over the handle and the top surface. This grip is generally perpendicular to the cutting edge. Alternatively, the thumb may be pressed against the back 104 and the remaining figures pressed against surface 103. This too is a perpendicular grip. In variations, the handle may be placed in between two of the fingers. The shaver body is symmetrical so that it can be held in either hand.

As can be understood from the various embodiments, the present shaver is different from the prior art in that it is meant to be held by holding the body within the hand and not held by the handle as is the case with the prior art shavers. That is, while the handle assists in securing the shaver body in the grip, the shaver of the present disclosure is not held solely by gripping the handle—gripping the shaver body is required for proper operation.

By gripping the shaver body as described, tips of one or more fingers are free to feel the skin and hair and thereby assist in using the shaver where the user cannot see the hairline. Therefore, while the size of the shaver may vary, it is generally sized such that the shaver body fits within the palm (or in some embodiments against or between a few fingers). The configuration of the shavers in this disclosure are unlike the prior art shavers which are designed to be held and manipulated by the handle. The present teachings enable the tips of one or more fingers to extend beyond the edges of the shaver body and feel the hair to be cut and guide the shaver.

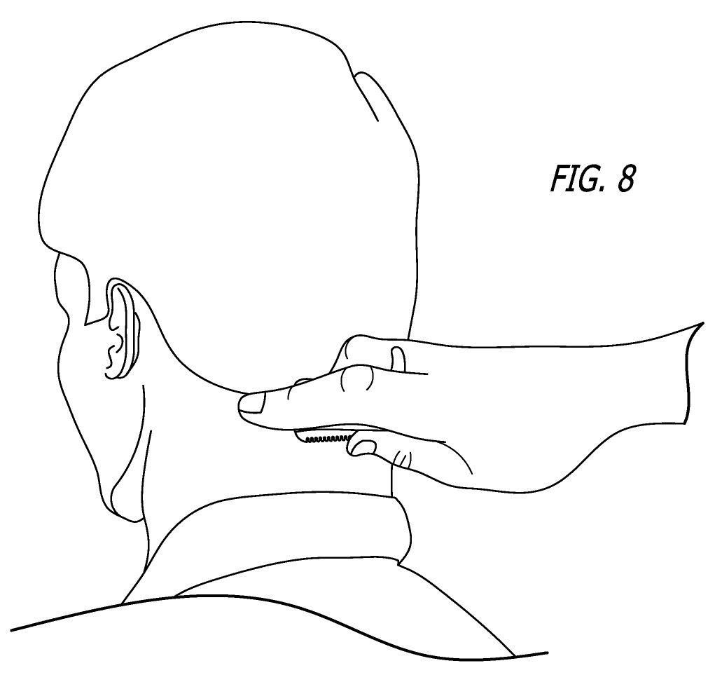

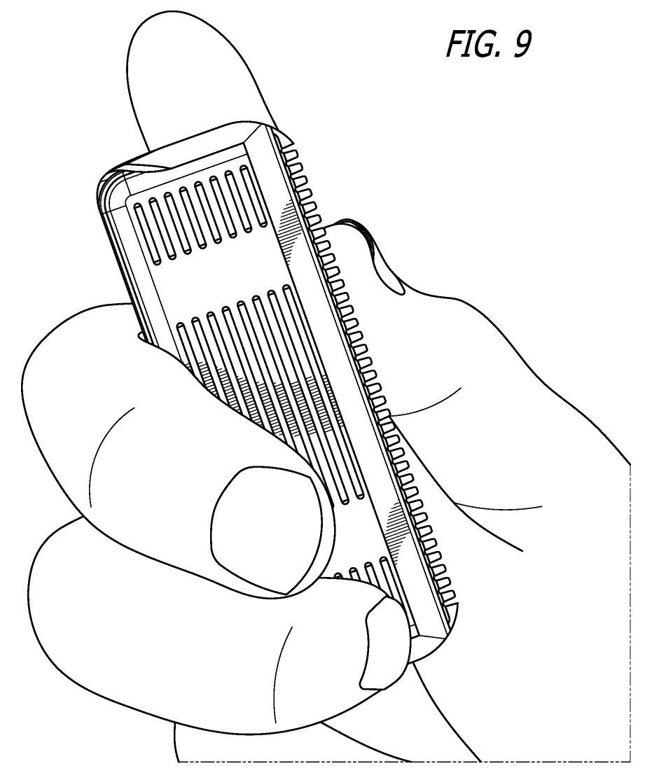

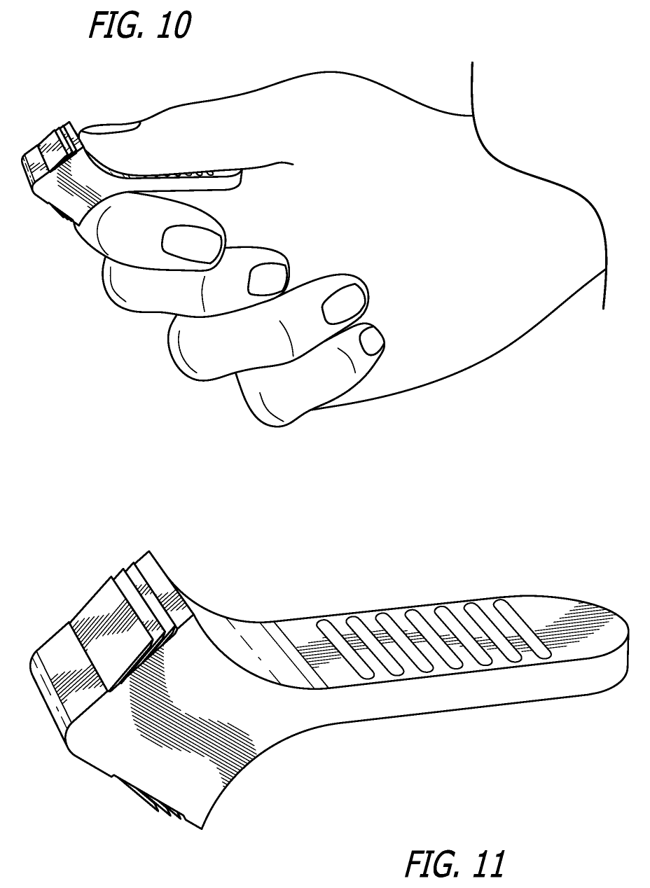

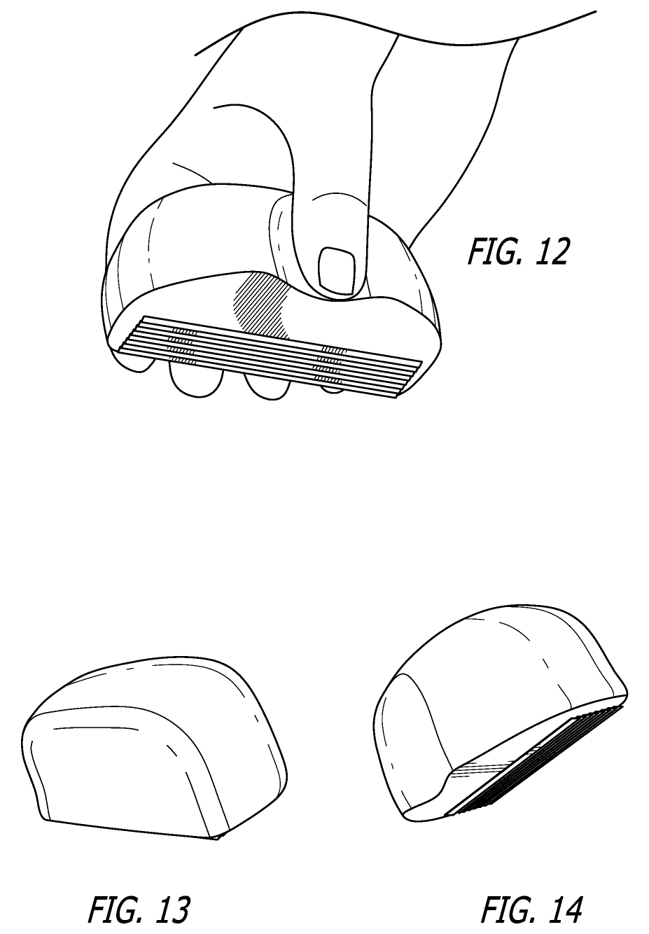

FIGS. 10-23 show alternative configurations for the shaver’s formfactor that incorporate these concepts. For example, the shaver in FIGS. 10-11 has an extended handle. But it is still configured to be held by the shaver body and in a manner that enables the user’s fingers to feel the hair line and guide the shaver without the benefit of line of sight. The configuration of FIGS. 12-14 are designed to have no extended handle.

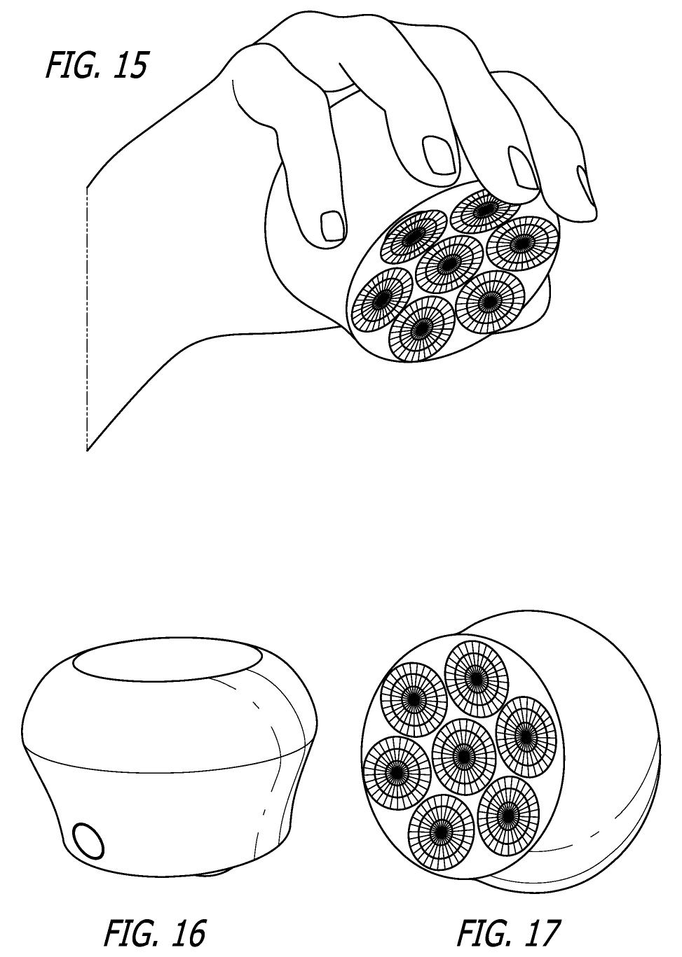

In the embodiment of FIGS. 15-17, the teachings of this disclosure are incorporated into the design of an electric shaver with seven round shaving elements as is known in the art. But the novel configuration of this shaver permits shaving without the benefit of sight. Incidentally, more or less than seven shaving elements, or other types of shaving elements as are known in the art, may be used without limitation.

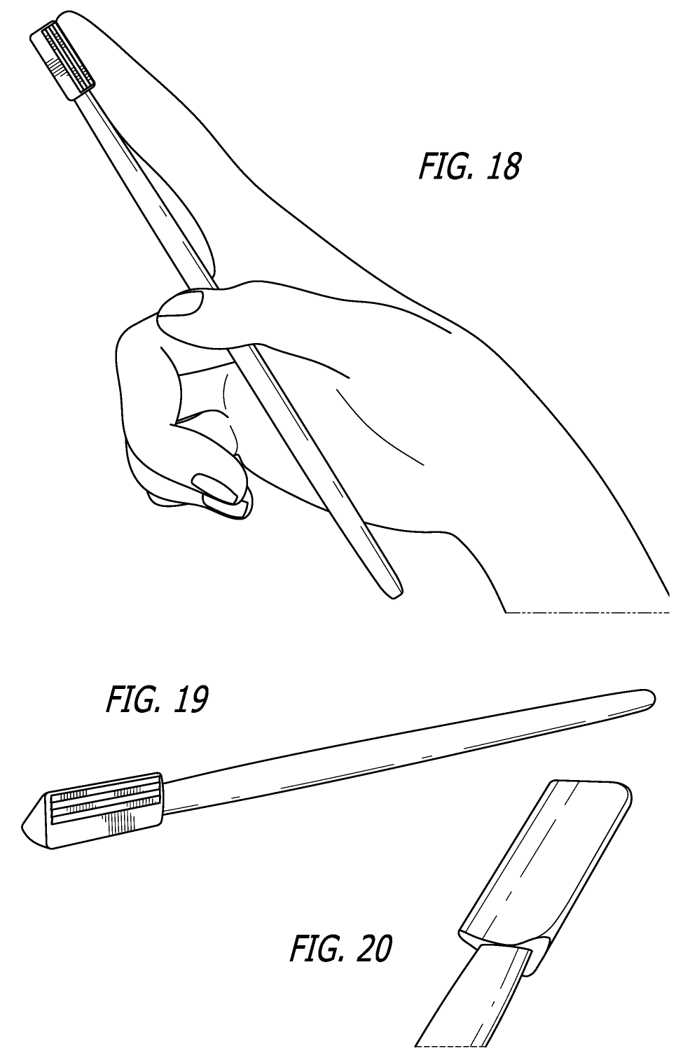

In FIGS. 18-20, the shaver body is small for more delicate operations or for cutting with more precision or in more precise patterns. The shaver body is coupled to a longer handle, resembling a wand. Here again, the user’s grip is able to hold and manipulate the shaver body with ease while maintaining contact with the hairline or the area to be shaved.

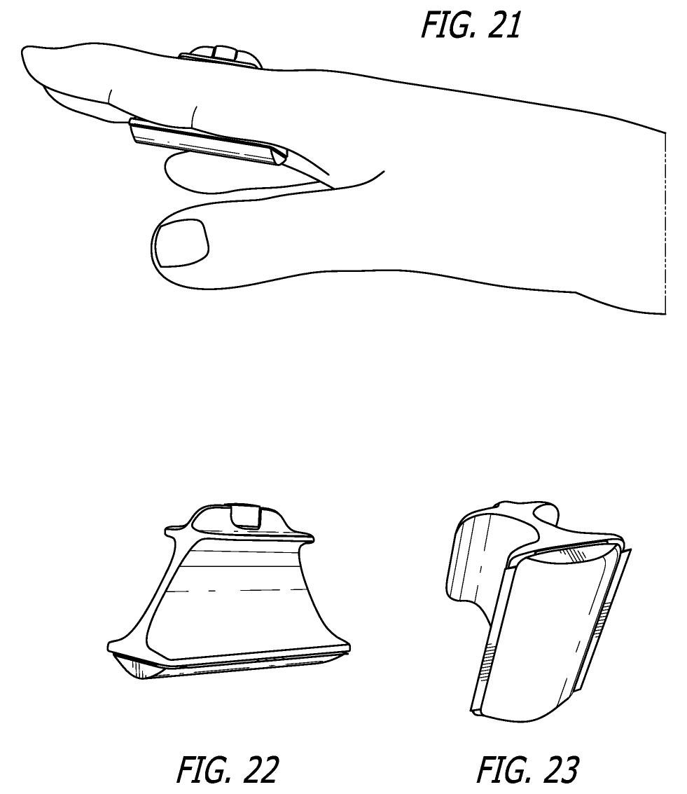

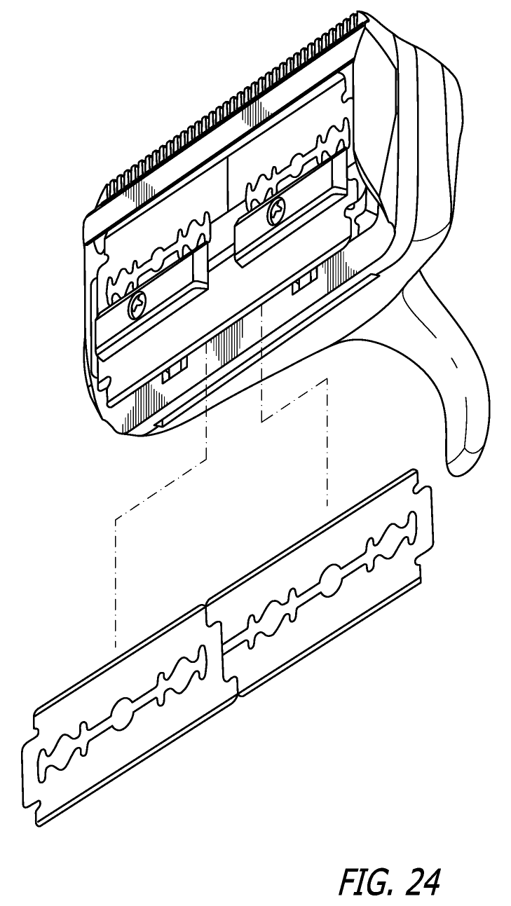

In the embodiment of FIGS. 21-23, the shaver is configured to fit between two fingers, in this case the index and middle finger. But the shaver body may be contoured for facile placement between other fingers as well. Again, the shaver body is configured to allow the user’s finger or fingers to maintain contact with the area to be shaved so that the cutting surface may be guided along the shaving path without the need to see the area being shaved. In the embodiment of FIGS. 21-23, the cutting surfaces are on either side of the bottom as shown in FIG. 23. But the shaver may be designed to have cutting surfaces on only one side, or on all four sides, or even three sides.

As stated above, the shaver may be formulated in different sizes. In one embodiment, the width (along the leading edge 113 in FIG. 2) may be less than seven inches. In shavers sized for the average hand, the width may be between 2 to 5 inches.

In other embodiments, the handle may be designed to be wider or narrower than the proportions shown in the figures. It may also be designed to be shorter or longer than shown. It may be curved, straight, a loop, or a bump. Despite the shape, the present handle in many of the embodiments is generally shorter than traditional handles because it will not be long as compared with the height of the body and will be generally shorter than the width of the body (the dimension from one side 112 to the other side 112) as shown along section 6-6 in FIG. 2, for example. That is, the protrusion of the handle above the surface of the body is generally less than the width of the leading edge 113 in several of the embodiments.

The shaver may be made of any materials including metal, plastic, ceramics, or wood. It may be formed using traditional methods of carving, molding, potting, casting, or forging, or using more modern methods of 3-D printing, including 3-D printing of metal, additive printing or subtractive printing.

The blade insert assembly or cartridge made be made by encasing the blade in a refillable cartridge as is known in the shaving arts. It may be created as a one-time insert to be discarded after use, similar to disposable blades. Alternatively, the cartridge, or alternatively the shaver body, may be formed to allow the blade to be replaced directly inside, similar to old style razors where the top and bottom portions sandwiched the blade.

As explained with respect to FIG. 24, the present shaver may also be designed to directly receive a blade, for example a standard razor blade. The blade may be coupled to, fastened, slid, or snapped onto the bottom surface without the use of a cartridge. The blade may slide under a cover 207 (FIG. 4) which may be sized to cover a substantial area of the surface of the blade.

The present shaver may be constructed with replaceable cartridge-style blades as well. It may additionally be constructed with standard razor blades or even be adapted to receive electric cutting elements at the leading edge 113 (FIG. 2) similar to a trimmer. It may also be fitted with electric shaving elements as shown in FIG. 15.

Any of the described embodiments of the invention may be configured for used with any other features. The functions presently taught may be implemented in a single device with alternative features or in different versions of the device. Moreover, disposable and non-disposable versions of the shaver are contemplated hereby.

Moreover, the present shaver may be used when the hair to be cut is in view or when the hair is not visible to the user. Therefore, it is useful for seeing individuals when cutting hard-to-see places, such as the back of the neck, or for visually impaired individuals who may be unable to see the area to be shaved irrespective of its location.

Other modifications and variations will be apparent to the person of ordinary skill in the art in view of the present teachings without departing from the scope and spirit of these teachings. Such modifications or variations are contemplated by the disclosure and the teachings herein are intended as explanations to illuminate the present disclosure and not as limiting examples. The breadth and scope of the claims are not to be limited by the particulars set forth in the specific embodiments described.

I claim:

1. A shaver comprising:
a shaver body;
the body including a sides;
the body including a leading edge;
the leading edge extending from a first of said sides to a second of said sides;
the leading edge is configured to receive a blade;
wherein the shaver body is configured to be gripped by a human hand with fingers such that the tips of at least some of the fingers may extend beyond the edges of said shaver body to feel the hair to be cut.

2. The shaver of claim 1 wherein the shaver is configured to be gripped parallel to the leading edge.

3. The shaver of claim 1 wherein the shaver is configured to be gripped perpendicular to the leading edge.

4. The shaver of claim 1 wherein the leading edge includes teeth.

5. The shaver of claim 1 wherein the handle is less long than the leading edge is wide.

6. The shaver of claim 1 wherein the leading edge is configured to receive a cartridge, said cartridge containing said blade.

7. The shaver of claim 1 wherein the body has a curved surface.

8. The shaver of claim 1 wherein the body further includes a handle.

9. The shaver of claim 8 wherein the handle is curved.

10. The shaver of claim 1 wherein the leading edge is in contact with a blade coupled directly to the shaver body.

11. A shaver comprising:
a shaver body;
the body including sides;
the body including a leading edge;
the leading edge extending from a first of said sides to a second of said sides;
the leading edge is configured to receive a blade;
wherein the shaver body is configured to be gripped by a human hand such that a thumb may rest parallel to the leading edge to feel the hair to be cut.

12. A method of cutting hair comprising:
providing a shaver body; wherein the body includes sides; wherein the body includes a leading edge; wherein the leading edge extends from a first of said sides to a second of said sides; wherein the leading edge is configured to receive a blade;
holding the shaver by gripping the shaver body such that at least a portion of the grip can extend beyond an edge of the body and be in direct contact with the hair to be cut;
manipulating the shaver body such that the leading edge is placed adjacent to the hair;
cutting the hair by moving the shaver toward the hair until the blade severs the hair.

13. The shaver of claim 10 wherein the shaver is configured to be gripped parallel to the leading edge.

14. The shaver of claim 10 wherein the shaver is configured to be gripped perpendicular to the leading edge.

15. The shaver of claim 10 wherein the leading edge includes teeth.

16. The shaver of claim 10 wherein the body further includes a handle.

17. The shaver of claim 10 wherein the body is coupled to a handle.

18. The shaver of claim 10 wherein the handle is less long than the leading edge is wide.

19. The shaver of claim 10 wherein the leading edge receives a cartridge, said cartridge containing said blade.

20. The shaver of claim 19 wherein the handle is curved.
